(19) United States
(12) Patent Application Publication
(10) Pub. No.: US 2019/0095657 A1
(43) Pub. Date: Mar. 28, 2019

(54) POSITION-BASED COMPUTER TAMPERING DETERMINATION

(71) Applicant: Hewlett Packard Enterprise Development LP, Houston, TX (US)

(72) Inventors: John Norton, Houston, TX (US); David A. Moore, Tomball, TX (US); Steve Weingart, Chapel Hill, NC (US)

(21) Appl. No.: 15/716,792

(22) Filed: Sep. 27, 2017

(51) Int. Cl. G06F 21/88; G06F 21/86; G08B 13/14; G08B 13/24; H04W 4/04

(52) U.S. Cl. CPC G06F 21/88; G06F 21/86; H04W 4/04; G08B 13/2491; G08B 13/1427

(57) ABSTRACT

In some examples, a computing system can include a positioning sensor to acquire positioning data for the computing system and a non-transitory machine readable storage medium having stored thereon machine readable instructions. The instructions are to cause a computer processor of the computing system to: (1) receive positioning data from the positioning sensor; (2) determine whether the received positioning data indicates tampering of the computing system; and (3) perform an action to mitigate tampering when it is determined that the received positioning data indicates tampering of the computing system.

### BACKGROUND

Computer security can refer to the protection of computing systems from theft, damage, disruption, or other threats. Such security can seek to protect against threats that come via network access (e.g., downloadable viruses and malware), as well as certain threats available only through physical access to the hardware. Data centers are typically designed to provide robust security, and to prevent unwanted physical access to computer equipment. However, some workloads may require additional levels of security. Moreover, future IT growth in emerging markets may lead to the deployment of computing systems in data centers and other locations in which local support cannot be entrusted with access to critical data and Intellectual Property (“IP”).

### BRIEF DESCRIPTION OF DRAWINGS

FIG. 1 is a diagram of a computing system according to an example.

FIG. 2 is a diagram of a computing system according to another example.

FIG. 3 is a diagram of a computing system according to another example.

FIG. 4 is a diagram of a computing system according to another example.

FIG. 5 is a diagram of a computing system according to another example.

FIG. 6 is a diagram of a computing system according to another example.

FIG. 7 is a diagram of a portion of the example computing systems of FIG. 6.

### DETAILED DESCRIPTION

The following discussion is directed to various examples of the disclosure. Although one or more of these examples may be preferred, the examples disclosed herein should not be interpreted, or otherwise used, as limiting the scope of the disclosure, including the claims. In addition, the following description has broad application, and the discussion of any example is meant only to be descriptive of that example, and not intended to intimate that the scope of the disclosure, including the claims, is limited to that example. Throughout the present disclosure, the terms “a” and “an” are intended to denote at least one of a particular element. In addition, as used herein, the term “includes” means includes but not limited to, the term “including” means including but not limited to. The term “based on” means based at least in part on.

Certain implementations of the present disclosure can enable improved levels of physical security and data protection for edge computing and remote computing, networking, and/or storage deployments, such as for example certain infrastructure computing equipment deployed on utility poles or cell towers, or other equipment that cannot reasonably be placed within a secured perimeter. In some implementations, a computing system can include a positioning sensor to acquire positioning data for the computing system. The system can, for example, be programmed to cause a computer processor of the computing system to: (1) receive positioning data from the positioning sensor, (2) determine whether the received positioning data indicates tampering of the computing system, and (3) perform an action to mitigate tampering when it is determined that the received positioning data indicates tampering of the computing system.

Certain implementations of the present disclosure can help mitigate threats from certain lab-based attacks, which may result from theft of a computing system and transport to an alternative site that may provide greater resources to compromise the security of the computing system. Some examples of such lab-based security threats can, for example, include spying via: (1) leaking emanations, including unintentional radio or electrical signals, sounds, and vibrations; (2) X-ray imaging; and (3) large scale machining, (4) water jet/torture testing, sandblasting, shaped charge, etc. Position-based computer tampering determination and mitigation can help prevent or reduce the risk of such security threats. Other advantages of implementations presented herein will be apparent upon review of the description and figures.

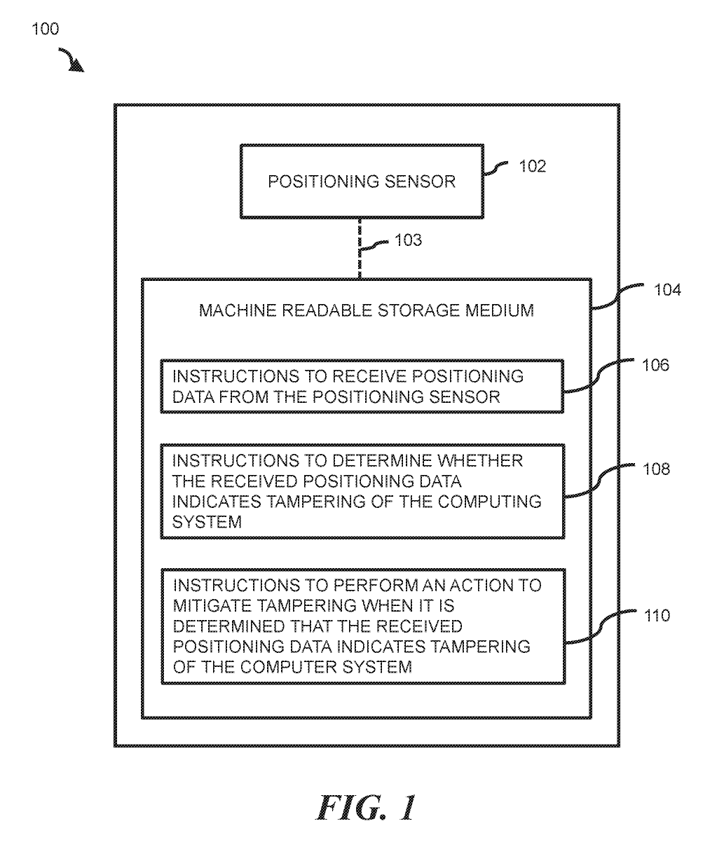

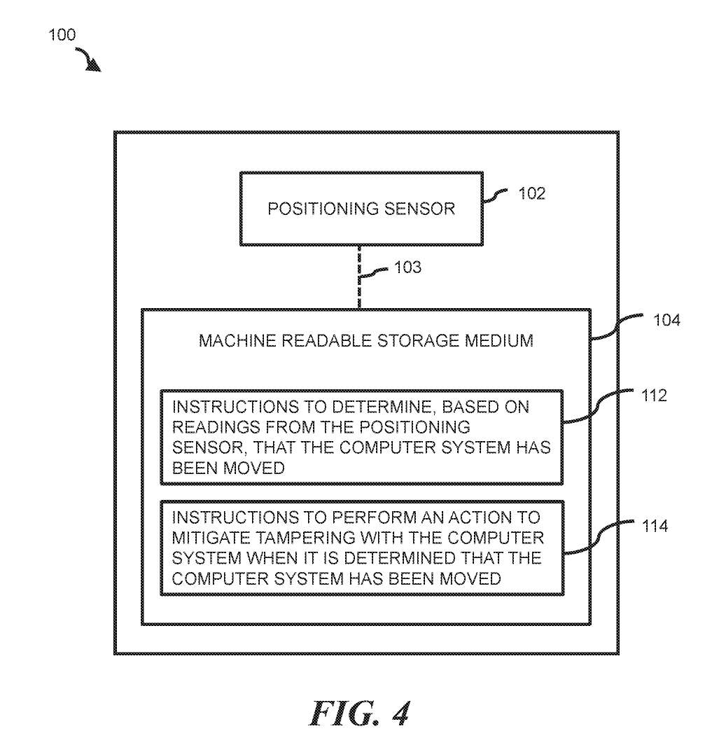

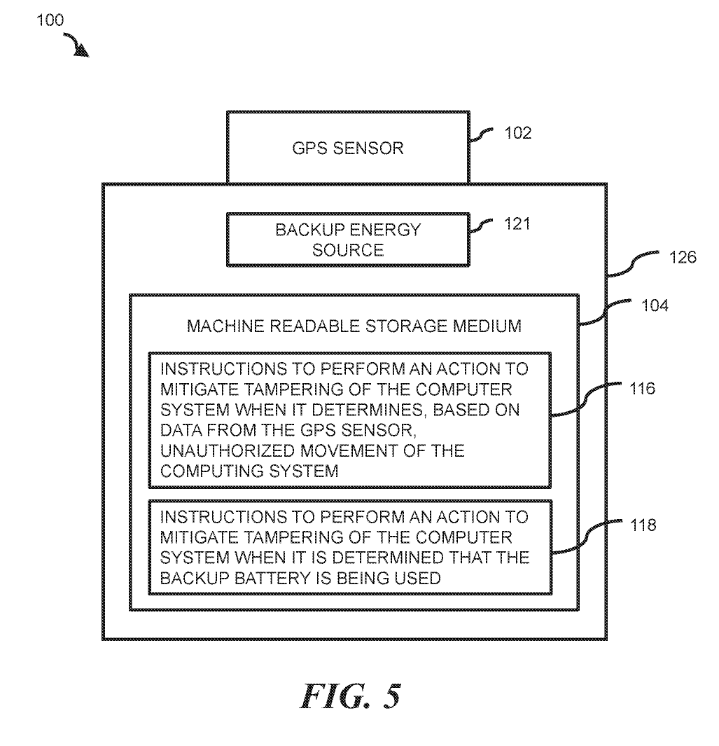

FIGS. 1-5 depict diagrams of various examples of a computing system 100. The various computing systems 100 can, for example, include a positioning sensor 102, a non-transitory machine readable storage medium 104, and/or other components as described in further detail below. The implementation of system 100 in FIGS. 1-3 includes instructions 106 to receive positioning data from positioning sensor 102, instructions 108 to determine whether the received positioning data indicates tampering of system 100, and instructions 110 to perform an action to mitigate tampering when it is determined that the received positioning data indicates tampering of system 100. The implementation of system 100 in FIG. 4 includes instructions 112 to determine, based on readings from positioning sensor 102, that system 100 has been moved and instructions 114 to perform an action to mitigate tampering with system 100 when it is determined that system 100 has been moved. The implementation of system 100 in FIG. 5 includes instructions 116 to perform an action to mitigate tampering of system 100 when system 100 determines, based on data from a GPS sensor (e.g., sensor 102 of FIG. 5), unauthorized movement of system 100; and instructions 118 to perform an action to mitigate tampering of system 100 when it is determined that a backup energy source (e.g., backup energy source 121 of FIG. 5) is being used.

It is appreciated that these examples may include or refer to certain aspects of other implementations described herein (and vice-versa), but are not intended to be limiting towards other implementations described herein. Moreover, it is appreciated that certain aspects of these implementations may be applied to other implementations described herein. As but one example, although FIG. 4 does not expressly depict a backup energy source, it is appreciated that in some implementations, computing system 100 of FIG. 4 may include a backup energy source, such as for example backup energy source 121 described with respect to FIG. 5.

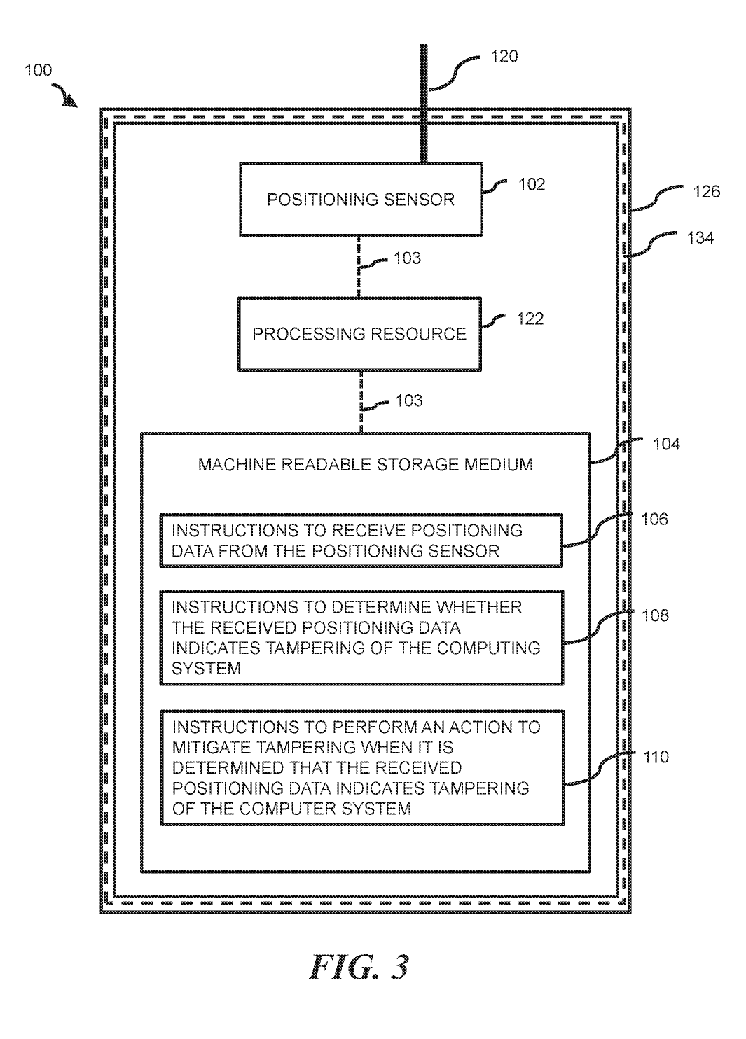

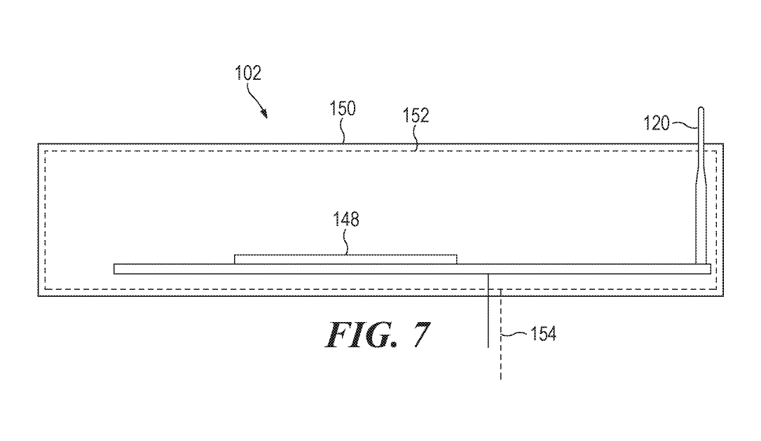

In some implementations, computing system 100 can include a positioning sensor 102, which can be used to acquire positioning data for computing system 100. Positioning sensor 102 can, for example, be in the form of a Global Positioning Satellite (GPS) sensor or other suitable positioning sensor. It is appreciated that the term “sensor” can also refer to a sensor assembly or module that includes various electronic components to assist in the determination of a position or location of computing system 100. For example, in some implementations, positioning sensor 102 can include an antenna (e.g., antenna 120 of FIG. 3), a dedicated processing resource, and dedicated power module to power one or more components of positioning sensor 102. An example positioning sensor 102 is also depicted and described below with respect to FIG. 7. In some implementations, positioning sensor 102 is a sensor for the GLONASS Global Navigation Satellite system. In some implementation, positioning sensor 102 is able to use localized telemetry systems operating at a facility or other level. Such an implementation can, for example, be used when satellite signals are blocked, when system 100 experiences an equipment failure, or in other situations. In some implementations, positioning sensor 102 can rely on Bluetooth Low Energy (BLE), beacon location services, and/or other suitable location technology.

As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software can include hardware only (i.e., a hardware element with no software elements), software hosted at hardware (e.g., software that is stored at a memory and executed or interpreted at a processor), or hardware and software hosted at hardware. It is further appreciated that the term “module” is additionally intended to refer to one or more modules or a combination of modules. Each module of system 100 can, for example, include one or more machine-readable storage mediums and one or more computer processors.

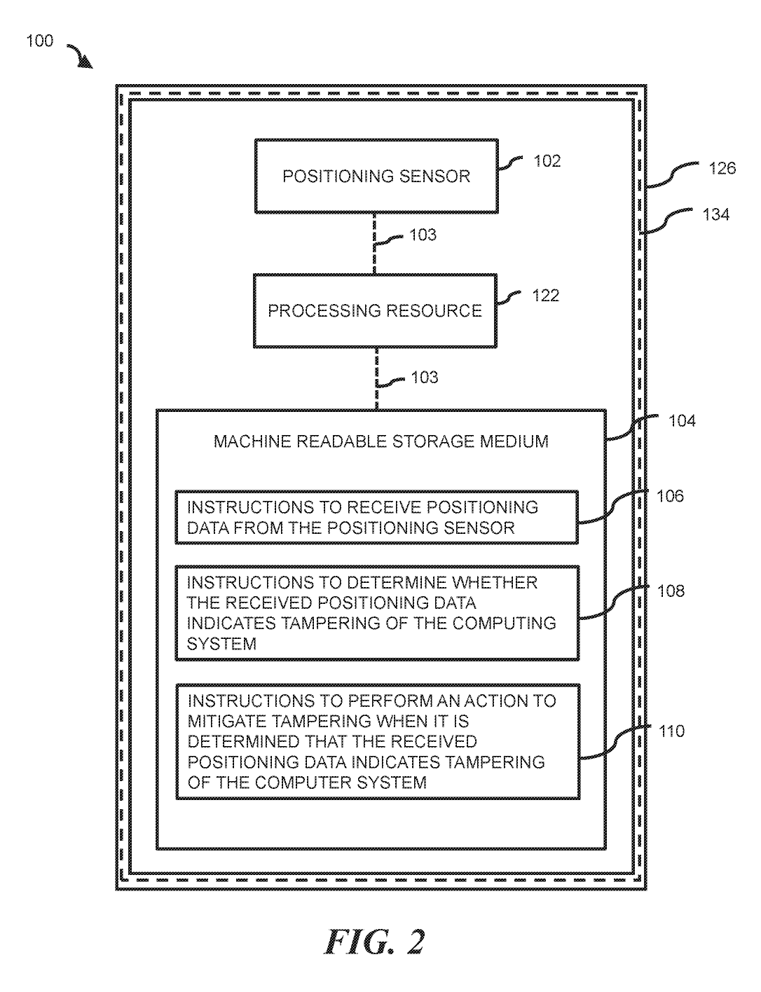

In some implementations, computing system 100 can include a processing resource (e.g., processing resource 122 of computing system 100 of FIG. 2). Processing resource 122 can, for example, be in the form of a central processing unit (CPU), a semiconductor-based microprocessor, a digital signal processor (DSP) such as a digital image processing unit, other hardware devices or processing elements suitable to retrieve and execute instructions stored in a memory resource or storage medium (e.g., medium 104), or suitable combinations thereof. Processing resource 122 can, for example, include single or multiple cores on a chip, multiple cores across multiple chips, multiple cores across multiple devices, or suitable combinations thereof. Processing resource 122 can be functional to fetch, decode, and execute instructions as described herein. As an alternative or in addition to retrieving and executing instructions, processing resource 122 can, for example, include at least one integrated circuit (IC), other control logic, other electronic circuits, or suitable combination thereof that include a number of electronic components for performing the functionality of instructions stored on storage medium 104. The term “logic” can, in some implementations, be an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Processing resource 122 can, for example, be implemented across multiple processing units and instructions may be implemented by different processing units in different areas of system 100.

Storage medium 104 can be in communication with positioning sensor 102 or another component of system 100 via a communication link 103. Each communication link 103 can be local or remote to a machine (e.g., a computing device) associated with processing resource 122. Examples of a local communication link 103 can include an electronic bus internal to a machine (e.g., a computing device) where storage medium 104 is one of volatile, non-volatile, fixed, and/or removable storage medium in communication with processing resource 122 via the electronic bus.

In some implementations, computing system 100 can include non-transitory machine readable storage medium 104 having stored thereon machine readable instructions (e.g., instructions 106, 108, 110, 112, 114, 116, and/or 118, etc.), which are described in further detail below. Storage medium 104 can, for example, be in the form of a non-transitory machine-readable storage medium, such as a suitable electronic, magnetic, optical, or other physical storage apparatus to contain or store information such as machine-readable instructions, etc. It is appreciated that other memory resources beyond non-transitory machine-readable storage mediums can be used with certain implementations of the present disclosure. Such instructions can be operative to perform one or more functions described herein. Storage medium 104 can, for example, be housed within the same housing as processing resource 122 for computing system 100, such as within a computing tower case, server rack, or standalone enclosure for computing system 100. In some implementations, storage medium 104 and processing resource 122 are housed in different housings. As used herein, the term “machine-readable storage medium” can, for example, include Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof. In some implementations, storage medium 104 can correspond to a memory including a main memory, such as a Random Access Memory (RAM), where software may reside during runtime, and a secondary memory. The secondary memory can, for example, include a nonvolatile memory where a copy of machine-readable instructions are stored. It is appreciated that both machine-readable instructions as well as related data can be stored on memory mediums and that multiple mediums can be treated as a single medium for purposes of description.

Instructions 106 stored on storage medium 104 can cause a computer processor of computing system 100 to receive positioning data from positioning sensor 102. Such positioning data can, for example, be in the form of an actual location of system 100 (e.g., GPS coordinates), relative location of system 100 (e.g., meters away from a beacon), or any other related, relevant, or suitable positioning data. For example, in some implementations, the received positioning data may not be sufficient to itself indicate a position or location of system 100, but may be combined with other data accessible by system 100 or another entity to indicate a position or location of system 100. For example, the received positioning data may indicate proximity of system 100 to a beacon but not the location of the beacon itself. This data may be combined with beacon location information stored locally on system 100 or retrieved by system 100 to determine an actual location of system 100 based on positioning data.

In some implementations, the positioning data can, for example, include a level of encryption. Such encryption can, for example, allow for a secure and trusted link between two end points (e.g., positioning sensor 102 and system 100). Such encryption can, for example, be used to protect against spoofing of positioning data and/or another purpose.

Instructions 108 stored on storage medium 104 can cause a computer processor of computing system 100 to determine whether the received positioning data indicates tampering of the computing system. Instructions 108 can, for example, indicate tampering when the positioning data indicates that the computing system has been moved out of a predetermined area. For example, a manufacturer of computing system 100 or other suitable entity can define an “authorized” area for operation of computing system 100 within a data center or other deployment location. For example, such an authorized area can be a building, a room within a building, a region within a room, the exact install footprint (e.g., a 4 foot by 3 foot area), etc. If computing system 100 is moved from this area (e.g., due to theft or another unauthorized purpose), then instructions 108 can be programmed to indicate tampering.

In some implementations, instructions 108 may not indicate tampering until it is determined that computing system 100 has been moved out of the predetermined area for a specific amount of time or other time-based criteria. For example, instructions 108 may instruct a processing resource to wait until computing system 100 has been moved out of a predetermined area for at least 1 hour before indicating tampering.

Likewise, instructions 108 can be programmed to indicate tampering when positioning data indicates that the computing system has entered a predetermined area. For example, a manufacturer of computing system 100 or other suitable entity can define an “unauthorized” area for operation of computing system 100. Such an unauthorized area can be small (e.g., a room within a building) or large (e.g., an entire country or other region). If computing system 100 is moved into such an area, then instructions 108 can be programmed to indicate tampering. In some implementations, instructions 108 may not indicate tampering until it is determined that computing system 100 has been moved into the predetermined area for a specific amount of time or other time-based criteria. For example, instructions 108 may instruct a processing resource to wait until computing system 100 has been present in a predetermined area for at least one hour before indicating tampering.

Instructions 108 can, in some implementations, be programmed to cause a computer processor of computing system 100 to perform an action to enable position-based tamper detection when it is determined that the received positioning data indicates that the computing system has left a predetermined area, entered a predetermined area, or in response to another position-based trigger. For example, instructions 110 may enable enhanced position-based security when computing system 100 is moved to a region where a security threat is likely.

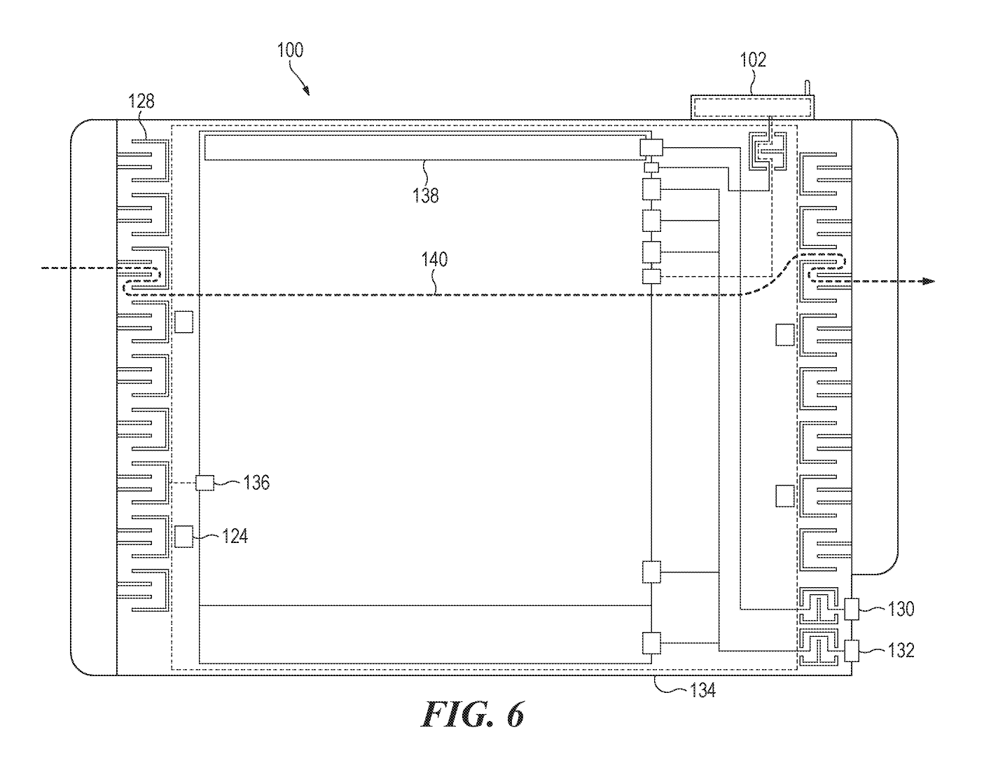

In some implementations, instructions 108 can be programmed to indicate tampering based on a combination of positioning data that indicates tampering and other information. As but one example, instructions 108 can be programmed to indicate tampering when positioning data indicates tampering only during a specific day of the week. As another example, instructions 108 can be programmed to indicate tampering only when the positioning data indicates tampering and system 100 detects an attempt at physical intrusion of an enclosure of system 100. As another example, system 100 can include temperature sensors (e.g., temperature sensors 124 of FIG. 6) to monitor temperature at one or more inlets and outlets of system 100 to detect and/or take action against a temperature attack on the hardware. In some implementations, system 100 can be programmed such that the detection of certain abnormal temperatures along with detection of position-based tampering can be sufficient (by itself or with other factors) for instructions 108 of system 100 to indicate tampering.

In some implementations, instructions 108 can be programmed to indicate tampering when no positioning data is received from positioning sensor 102. In such an implementation, the positioning data, can, for example, be in the form of a NULL data set (or other suitable data structure) to indicate that positioning data was not received or is not available. It is appreciate that other such formats may be supplied and that the term “received positioning data” may refer to a failure to receive expected positioning data. In some implementations, “positioning data” can refer to data indicating the disabling or other disruption of positioning sensor functionality. For example, instructions 108 can be programmed to indicate tampering upon detection of an attempt to remove or damage positioning sensor 102.

Instructions 110 stored on storage medium 104 can, for example, cause a computer processor of computing system 100 to perform an action to mitigate tampering when it is determined that the received positioning data indicates tampering of computing system 100. In some implementations, such an action can be in the form of an alert that tampering has been detected. Such an alert can be in any suitable form, such as an electronic message sent by computing system 100, an audio, visual, or another type of alert, notification, etc. It is appreciated that in some implementations, such an action can be triggered when no positioning data is received or in response to some other error condition.

In some implementations, the action of instructions 110 can be in the form of disabling predetermined functionality of computing system 100. For example, wireless transmission of data for computing system 100 may be disabled in response to a determination of tampering. In some implementations, power input from backup energy source 121 and other power sources may be disabled in response to a determination of tampering. Disabling such power sources can, for example, mitigate a threat of tampering by preventing computing system 100 from turning on altogether. In some implementations, the action of instructions 110 can be programmed to render computing system 100 permanently unusable (e.g., “bricking” the system) or otherwise locking the system down. For example, in some implementations, the action of instructions 110 can lock down system 100 until an unauthorized user or other entity unlocks the system. In some implementations, system 100 can be unlocked through the use of a custom hardware and/or software tool.

In some implementations, the action of instructions 110 can be in the form of deleting certain data stored on computing system 100. For example, in some implementations, a class of sensitive data stored on computing system 100 can be deleted in response to a determination of tampering. In some implementations, all data stored on one or more storage mediums within computing system 100 can be deleted. Likewise, in certain situations, all data stored on computing system 100 can be deleted. It is appreciated that in some implementations, data can additionally or alternatively be encrypted, locked down, backed up, etc., in response to a determination of tampering.

In some implementations, instructions 110 can cause a computer processor to perform multiple actions to mitigate tampering. Such multiple actions can be performed sequentially, in parallel, or another suitable timing or order. For example, in some implementations, a first action can be in the form of a notification to a local and/or remote IT administrator or other suitable entity and a second action, performed in parallel with the first action, can be in the form of deleting sensitive data from computing system 100. It is appreciated that any number of actions can be performed to mitigate tampering.

In some implementations, system 100 can be configured with a cryptographic key. If security is compromised in transit, the key can be “zeroed” by security measures within system 100. When the equipment is installed at its usage location, the key is used to generate an encrypted one-time key during a start up process, which can, for example, be transmitted back to the customer for validation. This can, in some situations, be used to ensure that tamper detection has not been triggered and the unit has maintained security throughout delivery and setup.

In some implementations, computing system 100 can include an enclosure housing 126. Such an enclosure housing 126 can, in some implementations, merely enclose one or more components of computing system 100 and prevent against electrical shock, water, dust, or other environmental threats. In some implementations, enclosure housing 126 can include one or more features to prevent or mitigate tampering with components of computing system 100. For example, certain implementations of the present disclosure can provide for tamper resistant airflow (e.g., perforated door 128 of FIG. 6) and cable egress (e.g., network connection 130 and power connection 132 of FIG. 6). In some implementations, the enclosure may only expose certain connections, such as panel mount power and networking connections (see, e.g., network connection 130 and power connection 132 of FIG. 6).

Certain implementations of the present disclosure are directed to a hardened standalone enclosure, which can be capable of supporting 12U of computational resources or another suitable configuration. In some implementations, the enclosure can be a 10U compute general purpose rack server. The enclosure can, for example, be constructed of steel or other suitable material or combination of materials. In some implementations, enclosure housing 126 can include a lock to prevent the opening of housing 126 without a key. It is appreciated that housing 126 can include additional or alternative security features.

For example, in some implementations, housing 126 may include an intrusion tamper detection barrier (e.g., barrier 134 of FIG. 2). Barrier 134 can, for example, be disposed within housing 126 to detect intrusion of a foreign object in the enclosure housing. Intrusion detection can rely on a conductive layer of Mylar or another suitable foil, a flex circuit, Indium Tin Oxide, conductive ink, etc. In some implementations, the use of such a barrier can provide for active monitoring. Such active monitoring can additionally or alternatively be provided through the use of mechanisms such as a flexible circuit, conductive ink on polyester, etc.

In some implementations, barrier 134 can be in the form of an electrically conductive mesh that can provide an electrical signal to a component (e.g., module 136 of FIG. 6) of system 100 when the mesh is damaged, disturbed, or another criteria is met. As depicted for example in FIG. 6, a mesh or other tamper detection barrier 134 can line an entire interior of housing 126 (e.g., along a panel of housing 126), as well as along ports, vents, and other points of entries.

It is appreciated that one or more components, modules of components, or portions of components can be disposed inside of the intrusion tamper detection barrier 134. For example, in some implementations, positioning sensor 102 can, for example, include an antenna (see, e.g., antenna 120 in FIG. 3) that is at least partially exterior to an intrusion tamper detection barrier, for example as shown in FIG. 2.

As depicted in FIG. 5, system 100 can include a backup energy source 121. Backup energy source 121 can, for example, be used to run a clock circuit and retain configuration memory while system 100 is turned off. Backup energy source 121 can, for example, be in the form of a CMOS storage backup energy source or BIOS backup energy source. In some implementations, backup energy source 121 can be integrated as part of an uninterruptible power supply (UPS), to provide power to system 100 for a variable period after a power failure (e.g., a period to allow system 100 to be shut down gracefully. Backup energy source 121 can, for example, be in the form of a battery, such as a large valve regulated lead-acid batteries, wet cell lead-acid, nickel cadmium, lithium ion, or any other suitable battery type. Backup energy source 121 can, for example, be used to ensure active monitoring while in shipping and in power loss events. In some implementations, system 100 can indicate tampering upon disabling or disruption in service of backup energy source 121.

In some implementations, system 100 can indicate tampering upon prolonged operation of backup energy source 121. For example, system 100 can be programmed to indicate tampering when backup energy source 121 is used for more than one hour. This mode can, for example, be enabled after system 100 is successfully installed and such a prolonged power outage is unlikely. As another example, system 100 can be programmed to indicate tampering when backup energy source 121 is used for more than three weeks. This mode can, for example, be enabled when system 100 is shipped and before it is successfully installed. It is appreciated that the specific lengths of time provided herein are merely used as examples and such time-based criteria may be defined according to customer preference or other factors.

Various example implementations for the present disclosure will now be described. It is appreciated that these examples may include or refer to certain aspects of other implementations described herein (and vice-versa), but are not intended to be limiting towards other implementations described herein. Moreover, it is appreciated that certain aspects of these implementations may be applied to other implementations described herein.

FIGS. 6 and 7 provide diagrams of various aspects of computing system 100 and components thereof according to other examples. FIG. 6 depicts an example system 100 and FIG. 7 is an enlarged view of a positioning sensor 102 for use with system 100 of FIG. 6 and other implementations described herein.

As provided above, FIG. 6 depicts an example system 100 that implements an air-cooling solution. In this implementation, an airflow path 140 is provided between an intake side 142 of system 100 and an exhaust side 144 of system 100. Airflow can enter through a perforated door 128 to a probe resistant air plenum 146. System 100 can include temperature sensors 124 to detect abnormal intake and exhaust air temperatures, which may indicate a temperature-based attack on system 100. System 100 can further include a tamper detection barrier 134 that defines a secure area within system 100. Tamper detection barrier 134 can be in electrical communication with a module 136 or other hardware or component to assist in detecting and responding to tampering. It is appreciated that other aspects of barrier 134 described with respect to other implementations may be incorporated or applied to barrier 134 of FIG. 6.

System 100 of FIG. 6 can include a Top of Rack (TOR), interconnect module, or other network communication module 138 in communication with one or more network connections 130 of system 100. In some implementations, module 138 can allow for networked communication with other equipment. Module 138 can, for example, include a network interface controller having an Ethernet port and/or a Fibre Channel port. In some implementations, module 138 can include wired or wireless communication interface, and in some implementations, can provide for virtual network ports. In some implementations, module 138 includes hardware in the form of a hard drive, related firmware, and other software for allowing the hard drive to operatively communicate with other network equipment. Module 138 can, for example, include machine-readable instructions for use with communication the communication module, such as firmware for implementing physical or virtual network ports.

One or more power connections 132 can be electrically coupled to power one or more electronic components of system 100. Although FIG. 6 depicts an implementation of system 100 with an air-cooling solution, it is appreciated that one or more aspects described herein can be applied to other types of cooling solutions, such as liquid cooling or any suitable combination thereof.

FIG. 7 depicts a positioning sensor 102 that can be used with system 100. Sensor 102 can include various components to implement position-based detection. In some implementations, sensor 102 includes a sensor housing 150 with a suitable tamper detection barrier 152. Sensor 102 can further include an ASIC 148 and antenna 120 secured to a printed circuit board 150 or other suitable substrate. Antenna 120 can extend through tamper detection barrier 134 and housing 126 to optimize reception of wireless signals. One or more components of sensor 102 can be electrically coupled to other aspects of system 100 via a communication link 154, which can, for example, be in the form of traces, wires, or other means so as to transmit presence, location, and/or other information to a processor of system 100. It is appreciated that one or more aspects of other housings (e.g., housing 126), tamper detection barriers (e.g., barrier 134), communication links (e.g., link 103) can be incorporated in sensor 102 or in any other component or aspect described herein.

As provided above, FIG. 7 depicts an example system 100 that implements a liquid-cooling solution. As depicted in FIG. 7, an airflow path 140 is provided between an intake side 142 of system 100 and an exhaust side 144 of system 100. Airflow can enter through a perforated door 128 to a probe resistant air plenum 146. System 100 can include temperature sensors 124 to detect abnormal intake and exhaust air temperatures, which may indicate a temperature-based attack on system 100. System 100 can further include a tamper detection barrier 134 that defines a secure area within system 100. Tamper detection barrier 134 can be in electrical communication with a module 136 or other hardware or component to assist in detecting and responding to tampering. System 100 of FIG. 6 can include a Top of Rack (TOR), interconnect module, or other network module (module 138) in communication with one or more network connections 130 of system 100. Likewise, one or more power connections 132 can be electrically coupled to power one or more electronic components of system 100.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described. Thus, features described with reference to one or more implementations can be combined with other implementations described herein. As used herein, “a” or “a number of” something can refer to one or more such things. For example, “a number of widgets” can refer to one or more widgets.

What is claimed is:

1. A computing system comprising:
a positioning sensor to acquire positioning data for the computing system;
a non-transitory machine readable storage medium having stored thereon machine readable instructions to cause a computer processor of the computing system to:
receive positioning data from the positioning sensor;
determine whether the received positioning data indicates tampering of the computing system; and
perform an action to mitigate tampering when it is determined that the received positioning data indicates tampering of the computing system.

2. The system of claim 1, wherein the positioning sensor is a Global Positioning Satellite (GPS) sensor.

3. The system of claim 1, wherein the instructions are to cause a computer processor of the computing system to determine tampering of the computing system when the positioning data indicates that the computing system has been moved out of a predetermined area.

4. The system of claim 1, further comprising:
an enclosure housing for the computing system
an intrusion tamper detection barrier disposed within the enclosure housing to detect intrusion of a foreign object in the enclosure housing.

5. The system of claim 4, wherein the positioning sensor includes an antenna that is at least partially exterior to the intrusion tamper detection barrier.

6. The system of claim 4, wherein the storage medium is disposed inside of the intrusion tamper detection barrier.

7. The system of claim 1, wherein the action includes sending an alert that tampering has been detected.

8. The system of claim 1, wherein the action includes disabling predetermined functionality of the computing system.

9. The system of claim 1, wherein the instructions are to cause a computer processor of the computing system to:
determine whether the received positioning data indicates that the computing system has entered a predetermined area; and
perform an action to enable position-based tamper detection when it is determined that the received positioning data indicates that the computing system has entered the predetermined area.

10. The system of claim 1, wherein the instructions are to cause a computer processor of the computing system to:
determine whether the received positioning data indicates that the computing system has left a predetermined area; and
perform an action to enable position-based tamper detection when it is determined that the received positioning data indicates that the computing system has left the predetermined area.

11. The system of claim 1, wherein the instructions are to cause a computer processor of the computing system to:
determine that the received positioning data indicates tampering of the computing system when no positioning data is received from the positioning sensor.

12. The system of claim 1, wherein the acquired positioning data is to be encrypted to prevent spoofing of the positioning data.

13. A computing system comprising:
a positioning sensor; and
a non-transitory machine readable storage medium having stored thereon machine readable instructions to cause a computer processor of the computing system to:
determine, based on readings from the positioning sensor, that the computing system has been moved; and
perform an action to mitigate tampering with the computing system when it is determined that the computing system has been moved.

14. The computing system of claim 13, wherein the machine readable instructions are to cause a computer processor of the computing system to:
determine, based on readings from the positioning sensor, that the computing system has been moved outside of a predetermined area; and
perform an action to mitigate tampering with the computing system when it is determined that the computing system has been moved outside of the predetermined area.

15. A computing system comprising:
a secure enclosure for the computing system;
a Global Positioning Satellite (GPS) sensor external to the secure enclosure to determine a location of the computing system;
a non-transitory machine readable storage medium within the secure enclosure; and
a backup energy source to enable temporary operation of a tamper mitigation sub-system of the computing system when the computing system is not plugged in,
wherein the medium has stored thereon machine readable instructions to cause a computer processor of the computing system to:
perform an action to mitigate tampering of the computing system when it determines, based on data from the GPS sensor, unauthorized movement of the computing system; and
perform an action to mitigate tampering of the computing system when it is determined that the backup energy source is being used.

16. The computing system of claim 15, wherein the medium has stored thereon machine readable instructions to cause a computer processor of the computing system to:
perform an action to mitigate tampering of the computing system when it is does not received data from the GPS sensor after a predetermined time period.
